(19) United States
(12) Patent Application Publication
(10) Pub. No.: US 2023/0253770 A1
(43) Pub. Date: Aug. 10, 2023

(54) VARIABLE BUSHING WITH BIASED RAMP ASSEMBLY

(71) Applicant: Hubbell Incorporated, Shelton, CT (US)

(72) Inventors: Will Eisele, Rocky Hill, CT (US); Brian Bourgoin, East Haddam, CT (US); Frank Fiala, East Haddam, CT (US)

(73) Assignee: Hubbell Incorporated, Shelton, CT (US)

(21) Appl. No.: 18/167,053

(22) Filed: Feb. 9, 2023

Related U.S. Application Data
(60) Provisional application No. 63/308,323, filed on Feb. 9, 2022.

(51) Int. Cl. H02G 1/12

(52) U.S. Cl. CPC H02G 1/1224

(57) ABSTRACT

A tool for removing insulation from a cable that includes a housing, a blade, a ramp assembly, and a clearance window. The housing has a central opening. The blade has a cutting edge and is secured to the housing so that the cutting edge protrudes into the central opening. The ramp assembly has a cable support portion, a ramp base, and a biasing member. The cable support portion is pivotally connected to the ramp base, which is secured to the housing so that the ramp base protrudes into the central opening opposite the cutting edge. The clearance window is positioned with respect to the blade so that an insulation chip produced during removal of the insulation from the cable, during rotation of the housing and cable with respect to one another, travels through the clearance window. The biasing member biases the cable support portion away from the ramp base.

### CROSS REFERENCE TO RELATED APPLICATIONS

This application is based on claims benefit under 35 USC § 119 of U.S. Application 63/308,323 filed Feb. 9, 2022, the entire contents of which are incorporated herein by reference.

### BACKGROUND

### 1. Field of the Invention

The present invention relates to a variable bushing for stripping insulation from a cable, the bushing having a biased ramp assembly.

### 2. Description of Related Art

Many different insulation removal (stripping) tools are available in the market. These stripping tools fall into two categories: adjustable and fixed. Both types of tools need to accurately remove the insulation without damaging or scratching the conductor. This damage could lead to a failure once the cable is terminated and voltage applied.

Adjustable tools have an adjustable support platform to accommodate various cable diameters. An integrated cutting blade can be raised or lowered so the effective depth of cut can be changed by the end user. These tools are versatile and allow an end user in the field to use just one tool to effectively strip many different cable sizes and insulation thicknesses. Although these tools are effective, the set-up and specifically blade depth needs to be done with care and caution to ensure the tool will work correctly.

Fixed tools are purpose-built for a cable size and much easier to use. These fixed tools usually are in the form of a spinning bushing (cutting head) with an integrated cutting blade. These tools are designed to have a fixed bore to guide the cable and a corresponding fixed blade height for the specific insulation thickness. The bushings slide over the end of the cable and as they are rotated, the blade cuts into and removes the insulation, The cut insulation exits a clearance window in the bushing, downstream of the blade in the form of a “chip”. Typically, these bushings are part of a kit and sold with a tool holder to allow mounting and optional drill operability. The tool holder sometimes also has an integrated stop so the end user can set the length of insulation to be removed.

These tools are highly effective and precisely remove the insulation with no end user set-up. Once the correct bushing is chosen, the cut will be repeatable and correct. The main drawback is that they are size specific for the cable. The bushing must be closely sized to the outside diameter of the cable insulation. In addition, the blade depth must be accurately set to this specific bushing bore. If the bore is too tight, the cable will not fit. If the bore is too loose, the cable will have too much clearance and the blade will not have the proper depth relationship to the insulation and it might only partially cut or not at all if there is too much clearance. In addition, if there is too much clearance, the bushing will not reliably guide the cable, so even if the insulation is removed, the blade could score the conductor due to excessive clearance. Since the clearance needs to be tightly controlled, different bushings must be used as cable sizes change. When all of the applications are considered, many different bushings are required to cover all of the cable sizes, insulation thicknesses as well as other size influencing parameters; manufacturer-to-manufacturer tolerance, conductor condition (e.g., compressed, compacted) or conductor material (e.g., aluminum, copper).

### SUMMARY

Power cables are widely used in the industry to deliver power across a vast application range. Specifically, lower voltage power cable is used to distribute power to commercial, residential, or industrial buildings. This distribution can be in the form of overhead and underground applications and the category of application is commonly referred to as Secondary Cable and usually is for 600 v or lower applications. These cables have a nonmetallic coating (typically PVC) to insulate the copper or aluminum conductor. This protective insulation varies in application and thickness, but is rated to exist in indoor, outdoor, ducted underground and overhead/aerial duty conditions. A common reference to this category is THEN or THWN. Many limes, this cable will also have a very thin nylon jacket over the insulation for an added layer of mechanical abrasion and oil resistance. The cable ends must be terminated to remove the insulation so a connector fitting can be assembled to the cable. This can be in the form of a crimp lug or terminal block.

Due to the wide range of applications, there are many different cable sizes in this application family. Power demand dictates the wire gage and thermal and voltage rating dictate insulation thicknesses. Conductor materials are typically copper or aluminum, each having a different size for a given power rating (i.e., wire gage). In addition, the conductor geometry can be different for the same power rating. Stranded cable conductors are compressed to reduce airgap between the stranding, making the overall cable size smaller. However, this process adds cost, so some end users do not use compressed or compacted cable at the expense of a larger diameter cable. When these variables are considered, coupled with tolerance variation between manufacturers, there is a very wide range of conductor and finished cable diameter. The purpose of this invention is to provide an insulation removal/stripping tool that works across a wide range of cable sizes.

A tool for removing insulation from a cable is provided. The tool includes a housing, a blade, a ramp assembly, and a clearance window. The housing has a central opening for insertion of an end of the cable along a central axis. The blade has a cutting edge and being secured to the housing so that the cutting edge protrudes into the central opening. The ramp assembly has a cable support portion, a ramp base, and a biasing member. The cable support portion is pivotally connected to the ramp base, which is secured to the housing so that the ramp base protrudes into the central opening diametrically opposite the cutting edge. The clearance window passes from the central opening through the housing and is positioned with respect to the blade so that an insulation chip produced during removal of the insulation from the cable, during rotation of the housing and cable with respect to one another, travels through the clearance window and away from the housing. The biasing member biases the cable support portion away from the ramp base towards the central opening and the cutting edge.

In some embodiments either alone or together with any one or more of the aforementioned and/or after-mentioned embodiments, the biasing member is a compression spring.

In some embodiments either alone or together with any one or more of the aforementioned and/or after-mentioned embodiments, the ramp assembly includes a first spring land in the cable support portion that is configured and positioned to receive one end of the compression spring and a second spring land in the ramp base that is configured and positioned to receive another end of the compression spring.

In some embodiments either alone or together with any one or more of the aforementioned and/or after-mentioned embodiments, the ramp assembly includes a hinge pin and a hinge knuckle pivotally securing the cable support portion and the ramp base to one another.

In some embodiments either alone or together with any one or more of the aforementioned and/or after-mentioned embodiments, the ramp assembly has a living hinge pivotally securing the cable support portion and the ramp base to one another.

In some embodiments either alone or together with any one or more of the aforementioned and/or after-mentioned embodiments, further including a blade bridge disposed adjacent to the blade. The blade bridge has a portion that extends into the central opening further than the blade.

A tool for removing insulation from a cable is provided. The tool has a housing, a blade, a projection, and a clearance window. The housing has a central opening for insertion of a cable end and a housing outer surface. The blade has a cutting edge and is secured to the housing so that the cutting edge protrudes into the central opening. The projection is secured to the housing and includes a movable cable support portion extending into the central opening opposite the blade. The cable support portion is biased toward a central axis of the housing. The clearance window is disposed adjacent the blade and extends from the central opening to the housing outer surface whereby a chip produced during insulation removal travels through the window and away from the tool housing. The cable support portion of the projection urges a portion of the cable inserted into the central opening toward the blade. The insulation of the cable is cut by the blade edge and urged through the clearance window when the cable is rotated with respect to the tool housing.

In some embodiments either alone or together with any one or more of the aforementioned and/or after-mentioned embodiments, the protrusion is a ramp having a first profile depth at an end of the housing where the cable is inserted and a larger second profile depth toward an opposite end of the housing.

In some embodiments either alone or together with any one or more of the aforementioned and/or after-mentioned embodiments, the housing is cylindrical.

In some embodiments either alone or together with any one or more of the aforementioned and/or after-mentioned embodiments, further including a blade bridge disposed adjacent the blade wherein a portion of the blade bridge extends further into the central opening than the blade. The bridge ensures that the blade cannot touch the exposed conductor downstream of the strip regardless of how much the cable orbits in the central opening.

In some embodiments either alone or together with any one or more of the aforementioned and/or after-mentioned embodiments, the projection is secured to an end of a projection base and an end of the cable support portion. The projection base is secured tightly to the tool housing and the movable cable support portion urges the cable against the blade.

In some embodiments either alone or together with any one or more of the aforementioned and/or after-mentioned embodiments, further including a spring extending between the projection base and the cable support portion, urging the cable support portion toward the central axis wherein a cable is inserted into the central opening is urged against the blade cutting edge.

A method for removing insulation from a cable. The method includes providing a tool having a housing having a central opening for insertion of a cable end and a housing outer surface, a blade having a cutting edge, the blade secured to the cylindrical housing wherein the cutting edge protrudes into the central opening, a projection movably secured to the hosing, a portion of the projection extending into the central opening opposite the blade, the projection biased toward a central axis of the housing and a clearance window disposed adjacent the blade, the clearance window extending from the central opening to the housing outer surface whereby a chip produced during insulation removal travels through the window and away from the tool housing; providing a cable having insulation on the exterior surface of the cable; inserting the end of the cable into the central opening; allowing the projection to urge the cable against the blade; and rotating the cable in the central opening or rotating the tool housing about the cable wherein the insulation of the cable is cut by the blade edge and urged through the clearance window when the cable is rotated with respect to the tool housing.

In some embodiments either alone or together with any one or more of the aforementioned and/or after-mentioned embodiments, the tool includes a blade bridge disposed adjacent the blade wherein a portion of the blade bridge extends further into the central opening than the blade, and wherein the step of rotating the cable in the central opening includes the bridge ensuring that the blade cannot touch the exposed conductor.

The above-described and other features and advantages of the present disclosure will be appreciated and understood by those skilled in the art from the following detailed description, drawings, and appended claims.

### BRIEF DESCRIPTION OF THE DRAWINGS

FIG. 1 shows a front elevational view of the stripping tool according to the present disclosure;

FIG. 2 shows a rear elevational view of the stripping tool shown in FIG. 1;

FIG. 3 shows a top planar, view of the stripping tool shown in FIG. 1;

FIG. 4 shows a bottom plan view of the stripping tool shown in FIG. 1;

FIG. 5 shows a right top perspective view of the stripping tool shown in FIG. 1;

FIG. 6 shows a left top perspective view of the stripping tool shown in FIG. 1;

FIG. 7 shows a right elevational view of the stripping tool shown in FIG. 1;

FIG. 8 shows a left elevational view of the stripping tool shown in FIG. 1;

FIG. 9 shows a perspective view of a biased ramp assembly according to the present disclosure;

FIG. 10 shows a rear elevational view of the ramp assembly shown in FIG. 9;

FIG. 11a shows a first perspective view of the stripping tool blade and bridge according to the present disclosure;

FIG. 11b shows a second, opposite perspective view of the stripping tool blade and bridge according to the present disclosure;

FIG. 12 shows a perspective view of the ramp assembly shown in FIG. 9;

FIG. 13 shows a perspective view of the ramp assembly shown in FIG. 9;

FIG. 14 shows a perspective view of an alternate embodiment of a stripping tool according to the present disclosure;

FIG. 15 shows the stripping tool shown in FIG. 14 having portions removed to illustrate the various components of the assembly;

FIGS. 16a and 16b show the stripping tool shown in FIG. 1 before and during a stripping operation on a cable of a maximum diameter;

FIGS. 17a and 17b show the stripping tool shown in FIG. 1 before and during a stripping operation on a cable of a minimum diameter;

FIG. 18 is a first perspective view an alternate embodiment of a stripping tool according to the present disclosure;

FIG. 19 is a second perspective view of the stripping tool of FIG. 18;

FIG. 20 is a first side view of the stripping tool of FIG. 18;

FIG. 21 is a bottom view of the stripping tool of FIG. 18;

FIG. 22 is a first exploded perspective view of the of the stripping tool of FIG. 18;

FIG. 23 is a second exploded perspective view of the of the stripping tool of FIG. 18;

FIG. 24 is an exploded top view of the ramp assembly of the stripping tool of FIG. 18; and

FIG. 25 is an exploded bottom view of the ramp assembly of the stripping tool of FIG. 18.

### DETAILED DESCRIPTION

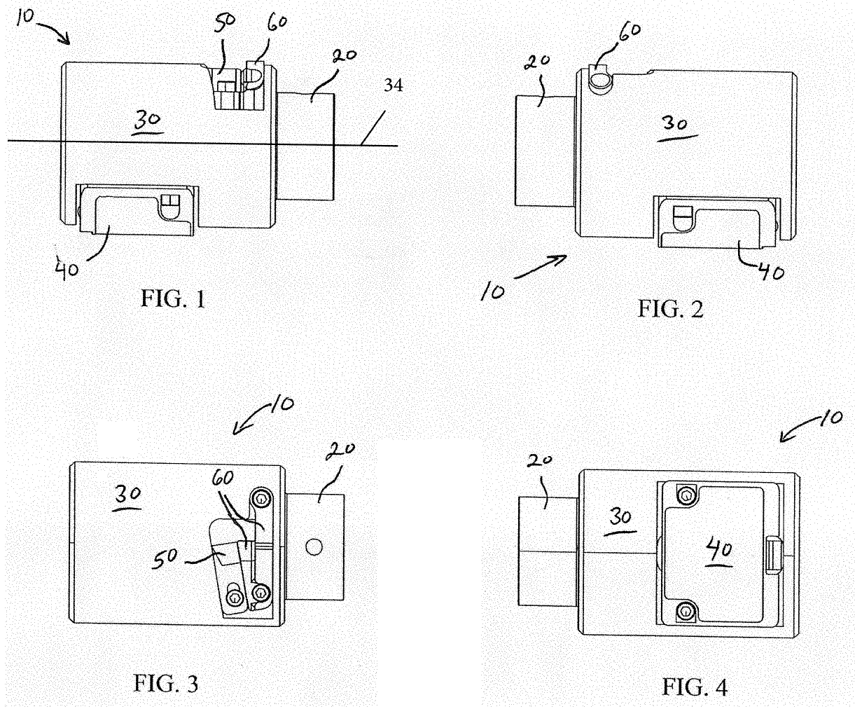

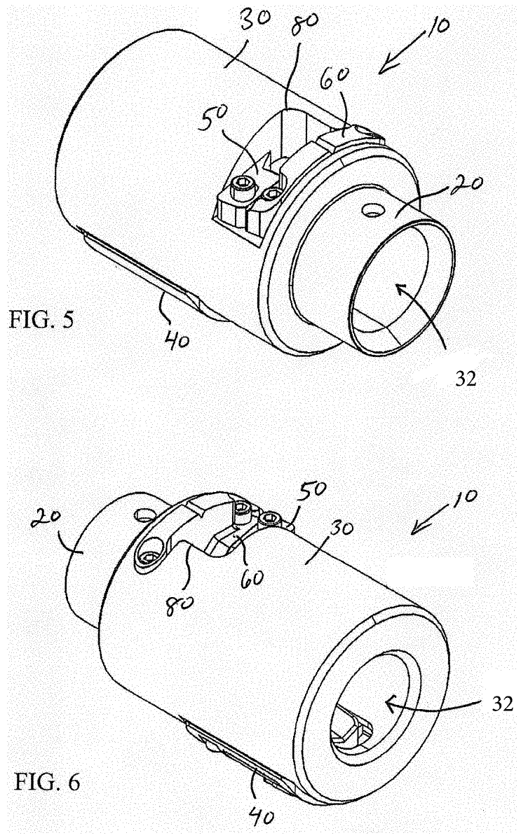

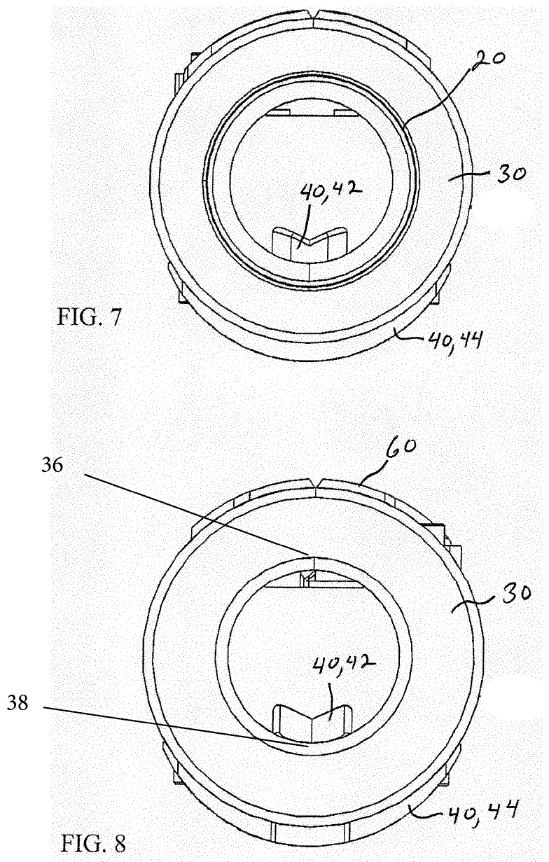

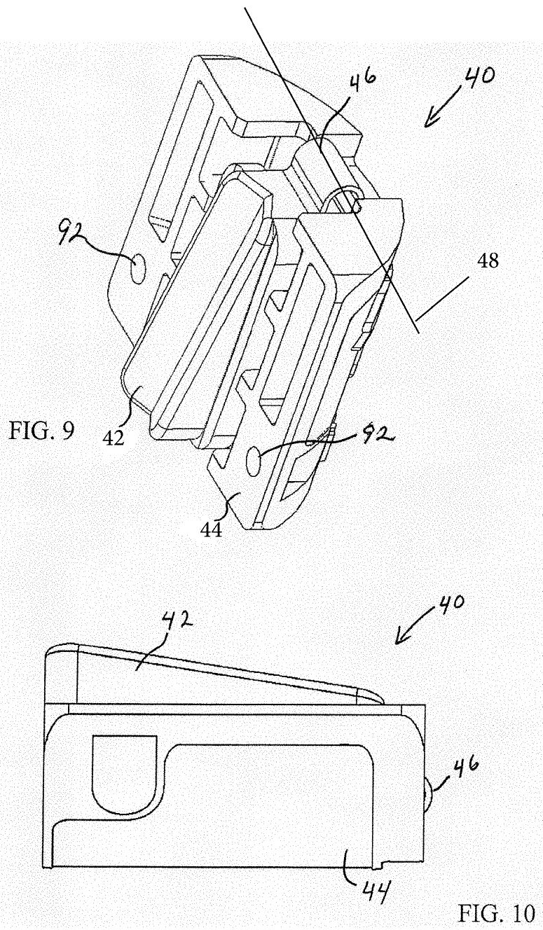

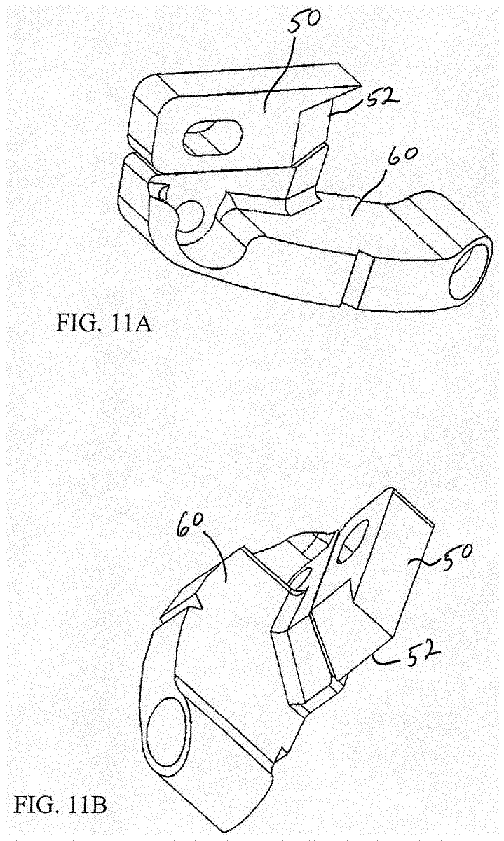

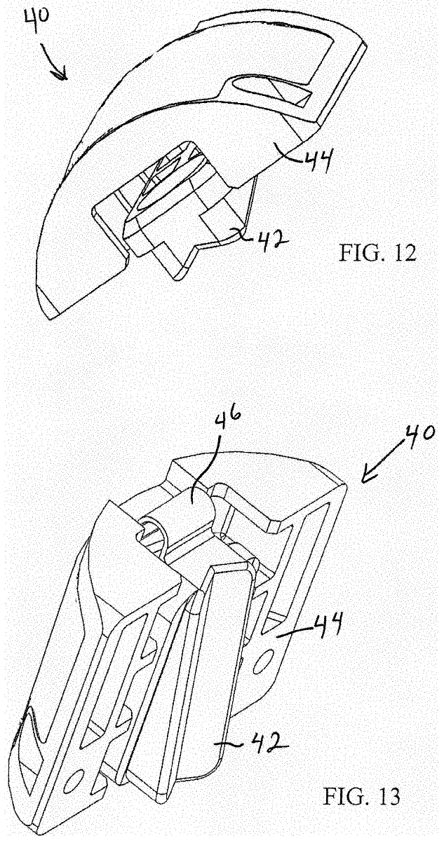

The present invention shown in FIGS. 1-15 of the drawings is a tool 10 for removing insulation from a cable. The tool 10 includes a housing or bushing 30 having a central opening 32 for insertion of a cable end. The tool 10 includes a blade 50 having a cutting edge 52, the blade 50 secured to the housing 30 wherein the cutting edge 52 protrudes into the central opening 32. The tool 10 includes a ramp assembly 40 secured to the housing including a movable cable support portion 42 extending into the central opening 32 opposite the blade, the cable support portion 42 is biased toward a central axis 34 of the housing and extends into the central opening 32 opposite the blade 50. The tool 10 includes a clearance window 80 disposed adjacent the blade 50, the clearance window 80 extends into the central opening 32 so that a chip produced during insulation removal travels through the window 80 and away from the tool housing 30. The cable support portion 42 of the ramp assembly 40 urges a portion of the cable inserted into the central opening 32 toward the blade 50. The insulation of the cable is cut by the blade edge 52 and urged through the clearance window 80 when the cable and tool housing 30 are rotated with respect to one another.

In some embodiments, housing 30 can include a driver receiver 20—that can be configured to receive a device for rotating tool 10 with respect to the cable. For example, driver receiver 20 can be configured for securing tool 10 to a drill.

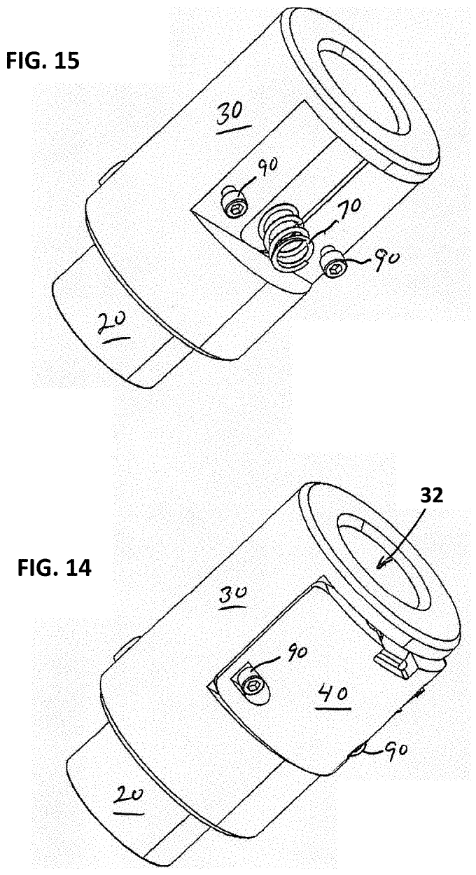

The tool 10 includes a blade bridge 60 disposed adjacent the blade 50 wherein a portion of the blade bridge 60 extends further into the central opening than the blade. In some embodiments, ramp assembly 40 includes a living hinge 46 secured to both an end of a ramp base 44 (FIG. 13) and an end of cable support portion 42, the ramp base 44 is secured tightly to the tool housing using fasteners 90 that extend through openings 92 and secured to the tool housing 30. The movable cable support portion 42 urges the cable against the blade edge 52 when the cable is fully inserted into the central opening 32. The tool 10 includes a including a biasing member 70—illustrated as a compression spring (FIG. 14)—between the ramp base 44 and the cable support portion 42, urging the cable support portion 42 toward central axis 34 and when a cable is inserted into the central opening 32 thereby urging the cable against the blade cutting edge 52.

While assembly 40 is shown by way of example having the biasing member 70 illustrated as a compression spring, it should be recognized that it is contemplated by the present disclosure for tool 10 have any desired biasing member that is configured to provide the desired biasing force. It is contemplated by the present disclosure for the biasing force on cable support portion 42 to be provided by biasing members 70 such as, but not limited to, extension springs, compression members (e.g., open or closed cell foams), helical springs, leaf springs, and the resiliency of living hinge itself. The biasing member 70 can be a separate element or formed integrally as one piece with a portion of assembly 40.

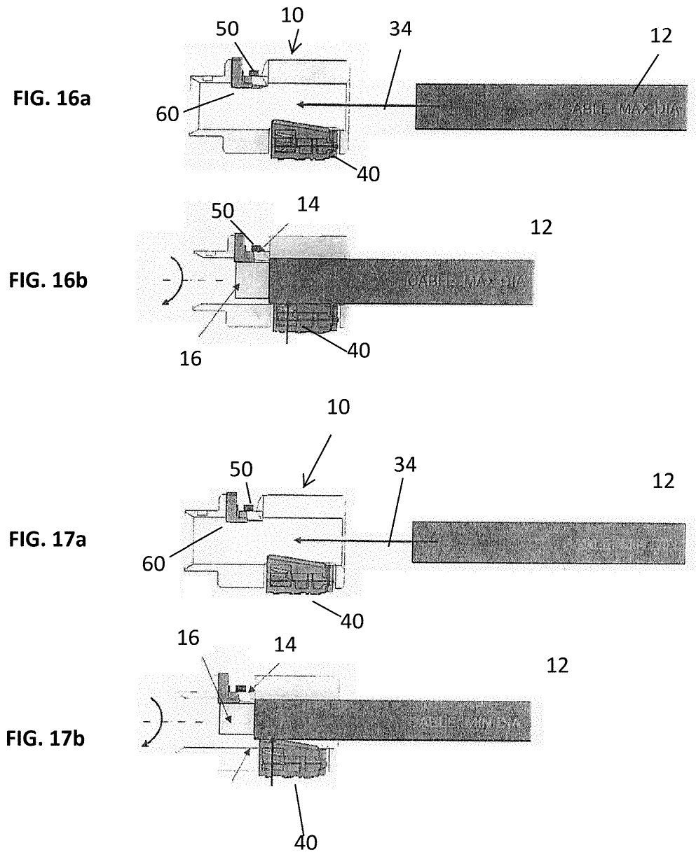

Referring now to FIGS. 16a-17b, tool 10 is shown in use with a cable 12. Here, a method for removing insulation 14 from a conductor 16 of cable 12 using tool 10 is shown. Cable 12 is shown in FIGS. 16a-16b with a maximum diameter and in FIGS. 17a-17b with a minimum diameter.

Cable 12 is inserted into central opening 32 of tool 10, the cable support portion 42 urges the cable against the blade 50. The method includes rotating the cable 12 in the central opening 32 or rotating the tool housing 30 about the cable 12 so that the insulation is cut by the blade edge 52 and urged through the clearance window 80 when the cables rotated with respect to the tool housing to expose conductor 16.

Tool 10 uses a variable bushing bore to work across a range of cable diameters. Specifically, tool 10 uses biased ramp assembly 40, which effectively changes the bushing bore size of housing 30. The protruding ramp assembly 40 is opposite the blade 50 so the cable 12 remains pushed into the blade 40. On prior art fixed bushings, if the bore of the housing is too large, the cable will not be adequately positioned to the cutting blade to initiate the cut. Advantageously, tool 10 ensures the clearance between cable 12 and blade 40 is effectively zero due to the biased ramp and protruding nature of the ramp assembly 40.

Accordingly, tool 10 works across a range of cable diameters as long as the biased ramp assembly 40 has adequate biasing force and travel to move the cable 12 to the upper tangent bore 36—namely into blade 50. The biased ramp assembly 40 ensures that, at the beginning of the cut, the cable 12 is positioned to the upper tangent bore 36 until the blade 50 can begin cutting into the insulation 14. Once the cut is started, the interaction between the blade 50 and “chip” of insulation 16 in clearance window 80 can provide upward reaction forces to hold the cable 12 at the upper tangent bore 36 to either supplement or replace the forces of the ramp assembly 40.

There is a realistic limit to how much range the biased ramp 42 can accommodate. for example, the protrusion could be designed to enter the bore by 0.125″ and this would allow all cable sizes within an approximate 0.125″ OD range to perform the same in this bushing. A diameter range of 0.125″ would effectively require multiple fixed bushings using the existing fixed bushing technology. This new design can easily be scaled to accommodate different sizes using the same biased and protruding ramp assembly 40. The height of the protrusion 42 just needs to be adjusted relative to the lower tangent 38 of the central opening 32 for a larger or smaller range. A set of 4 or 5 of tools 10 according to the present disclosure will easily strip insulation from cables having size ranges with which would previously have required 30 or more dedicated tools.

In some embodiments, support portion 42 can be made of or coated with a low friction material such as polymers. In some embodiments, support portion 42 and base 44 are formed as one piece using a living hinge 46. When actuated, the support portion 42 pivots about the living hinge 46 with respect to base 44 against the force of the biasing member 70. The ramp assembly 40 in this design has a rotary profile so it will act as a tapered ramp when the cable is installed along the longitudinal or central axis 34, but it provides a pivoting contact when the entire assembly is rotating during the stripping operation.

Tool 10 has a fixed height for blade edge 52. In this manner, although the biased ramp assembly 40 allows for a range of cable diameters, all cables used within each bushing will cut to the same depth (for example 0.065″). The blade 50 is installed on a fixed datum plane relative to the bore upper tangent 36.

In some embodiments, tool 10 can include a blade bridge 60 to create a beam of material immediately behind the blade 50. Bridge 60 can, in some embodiments, protrude into central opening 32 more than the blade edge 52 such that the bridge functions as a snubber. Once the insulation 14 is removed from cable 12, the exposed conductor 16 passes under the blade edge 52. For cables of the maximum diameter for tool 10, this is not an issue since the central opening 32 has adequate clearance for the cable 12, namely acts like a prior art specifically sized fixed tool. As the cable 12 gets smaller that the inner diameter of central opening 32, the biased ramp assembly 40 has to travel further, and the clearance increases between the cable outer diameter and inner surface of the central opening. As the clearance increases, the cable 12 can orbit or rotate relative to the axis 34. The biased ramp assembly 40 force is adequate lo push the cable 12 to the upper tangent 36 to start the cut, however in the event that the force is not be adequate to fully guide the cable 12 through central opening 32. This can be particularly problematic when an end user is removing the insulation 14 from cable 12 using drill (not shown) attached to driver receiver 20. Here, the blade bridge 60 can acts as a snubber to ensure that regardless of how much the cable 12 orbits, the blade edge 52 cannot touch the exposed conductor 16 downstream of where the insulation 14 was removed.

Tool 10 can use a separate non-metallic piece to form the blade bridge 60. It can be installed and positioned adjacent to the blade 50, the nonmetallic surface can directly contact the exposed conductor 16 and will not scratch or mark the surface of the conductor. Of course, it is contemplated by the present disclosure for the blade bridge 60 to be integrally formed as part of the inner surface of housing 30 in the central opening 32. In this embodiment, the blade bridge 60 can be made of or coated with a material that avoids damage to the exposed conductor 16.

Advantageously, tool 10 includes a central opening 32 with a biased ramp assembly 40 that positions cables of various diameters to the upper tangent 36—where the blade 50 is located. This ensures all cables, regardless of diameter, within a reasonable range, are all consistently presented to the blade 50 to initiate cutting action.

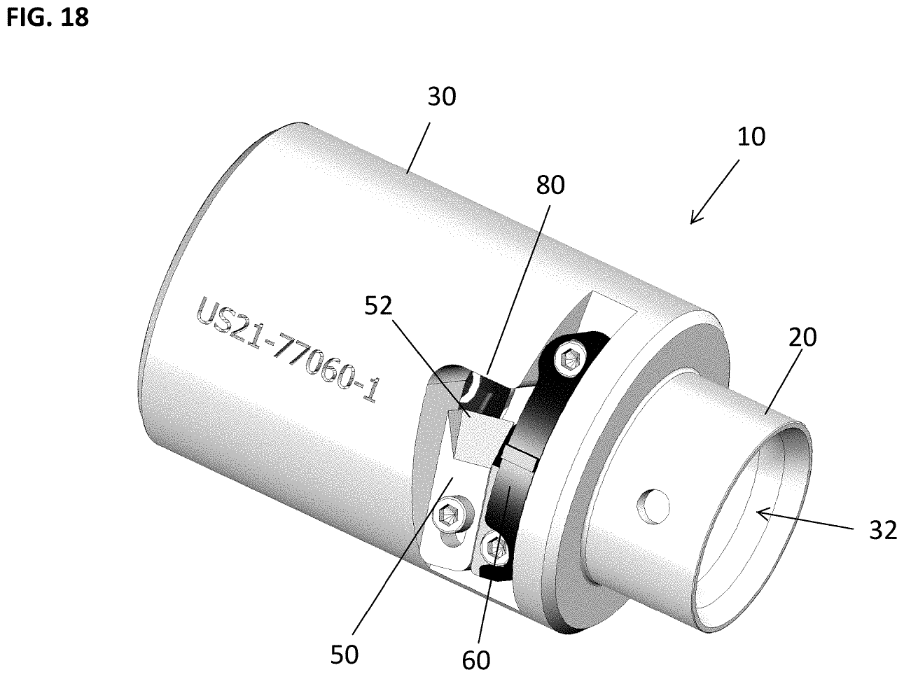

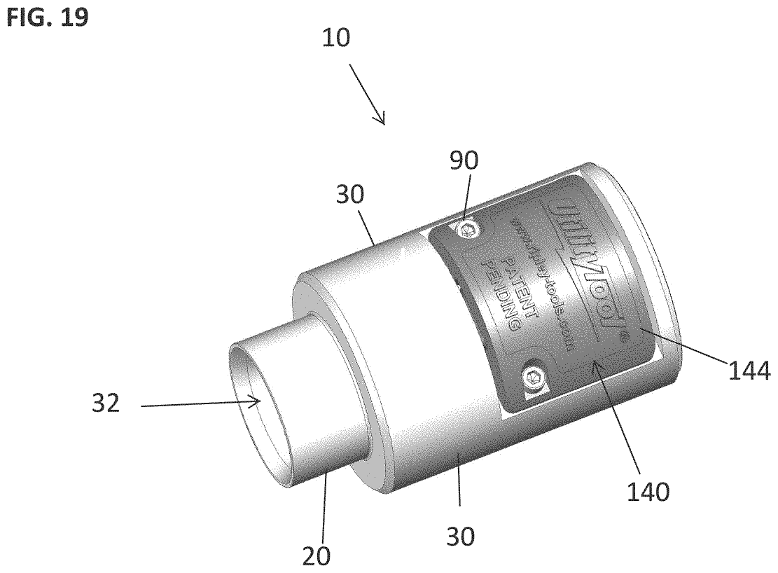

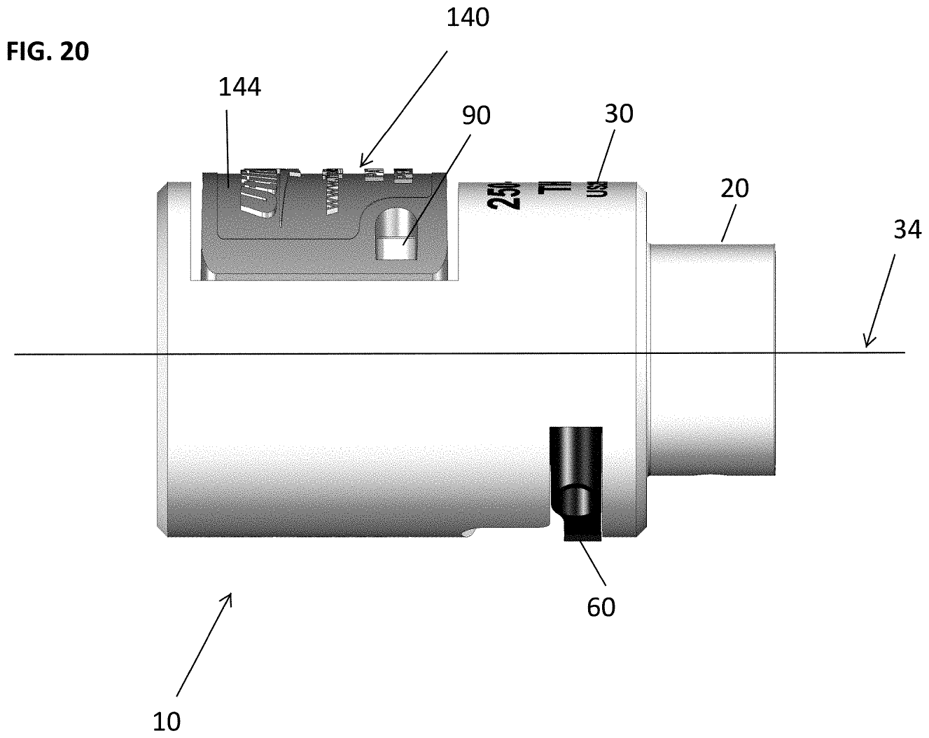

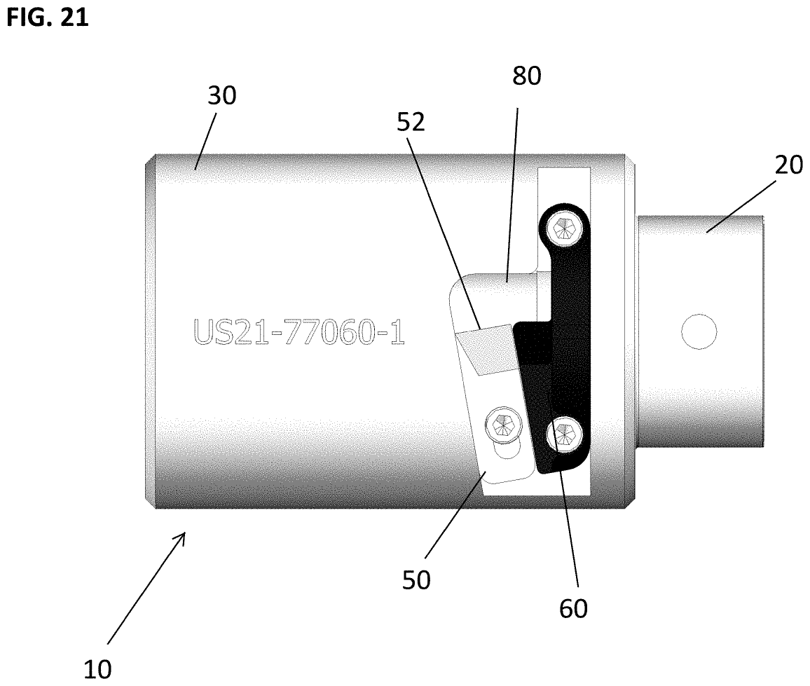

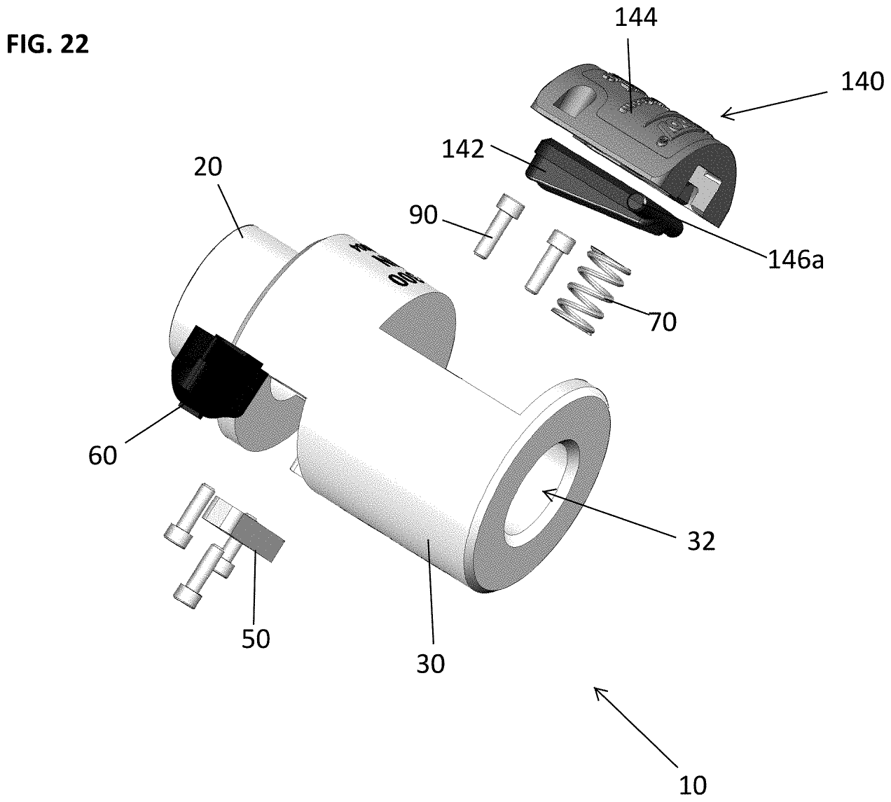

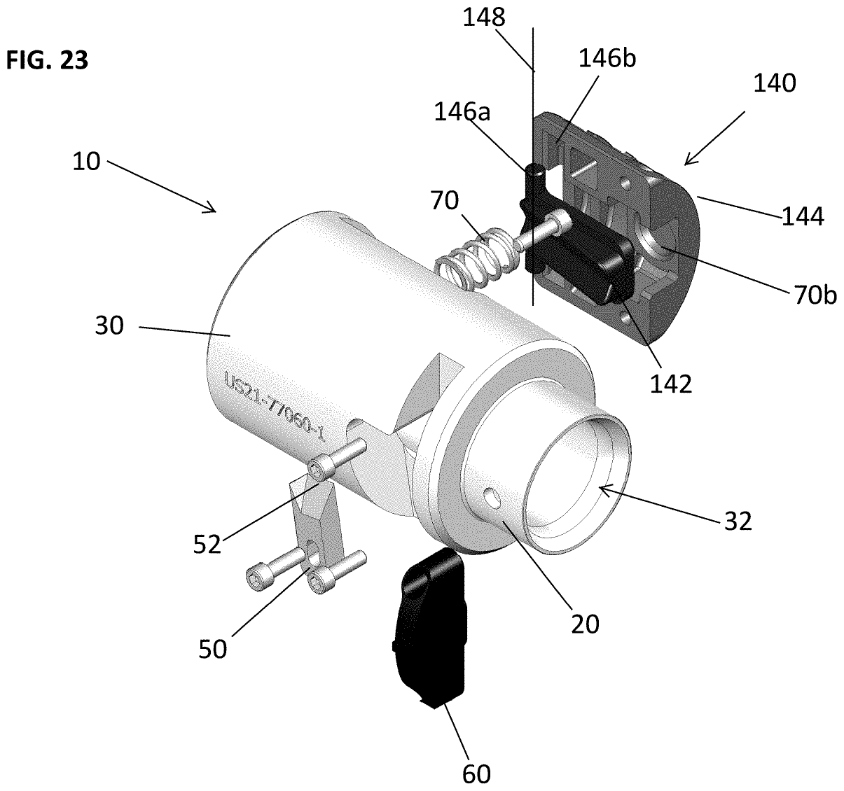

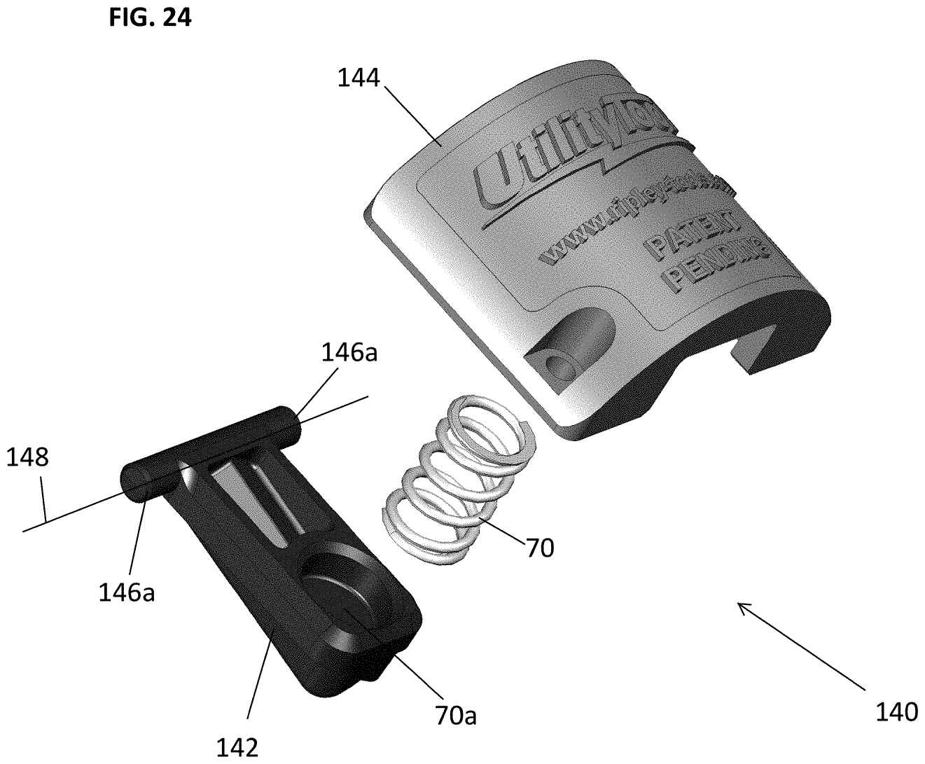

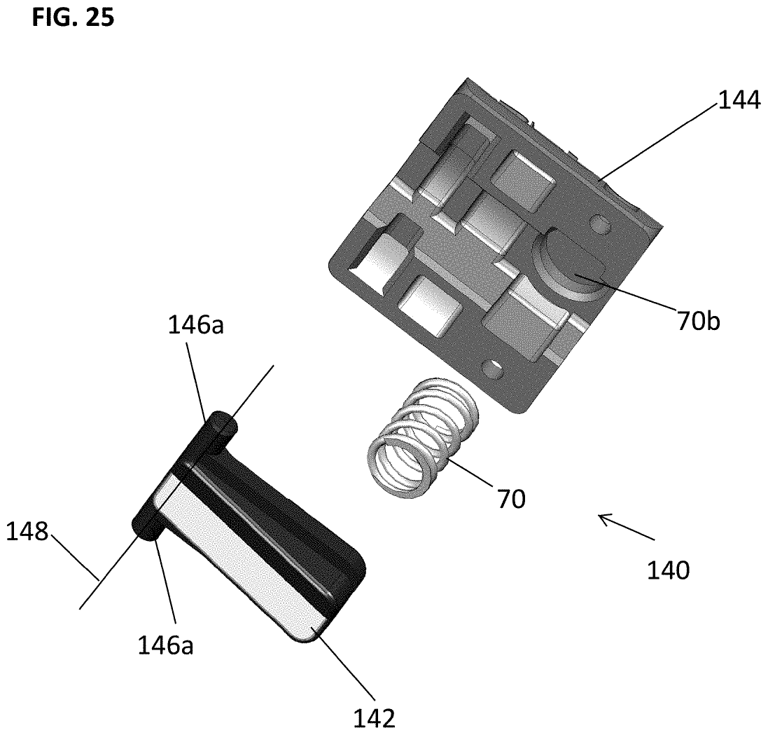

Referring now to FIGS. 18-25, a stripping tool 10 having an alternate exemplary embodiment of biased ramp assembly 140. Here, assembly 140 lacks the living hinge 46 of assembly 40 discussed in detail above.

Assembly 140 includes a movable cable support portion 142, a ramp base 144, and biasing member 70—which again is shown by way of example as a compression spring.

Support portion 142 includes a hinge pin 146a (two shown). Base 144 includes a corresponding hinge knuckle 146b (two shown). Pins 146a are received in knuckles 146b, respectively, to allow for pivoting movement of support portion 142 with respect to base 144 about a hinge axis 148, which is defined through pins the 146a.

It should be recognized that assembly 140 is shown by way of example having hinge pin 146a in support portion 142 and knuckle 146b in base 144. Of course, it is contemplated by the present disclosure for support portion 142 to have knuckle 146b and base 144 to have pin 146a.

Moreover, it should be recognized that assembly 140 is shown by way of example having hinge pin 146a integrally formed with support portion 142—or alternatively integrally formed with base 144. However, it is contemplated by the present disclosure for hinge pin 146a to be separately formed and operatively inserted through knuckles on both support portion 142 and base 144.

Assembly 140 can further include one or more lands 70a, 70b configured to operatively receive biasing member 70. In the illustrated embodiment, support portion 142 includes a first land 70a, while base 144 includes a second land 70b. In this manner, biasing member 70 is maintained in a desired positioned in assembly 140.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

LIST OF REFERENCE NUMERALS

| | |
|---|---|
| tool 10 | biased ramp assembly 140 |
| cable 12 | movable cable support portion 142 |
| insulation 14 | ramp base 144 |
| conductor 16 | hinge pins 146a |
| driver receiver 20 | hinge axis 148 |
| housing 30 | |
| central opening 32 | hinge knuckles 146b |
| central axis 34 | |
| upper tangent 36 | first land 70a |
| lower tangent 38 | second land 70b |
| biased ramp assembly 40 | |
| movable cable support portion 42 | |
| ramp base 44 | |
| living hinge 46 | |
| hinge axis 48 | |
| blade 50 | |
| cutting edge 52 | |
| blade bridge 60 | |
| biasing member 70 | |
| clearance window 80 | |
| fasteners 90 | |
| openings 92 | |

What is claimed is:

1. A tool for removing insulation from a cable, the tool comprising:
a housing having a central opening for insertion of an end of the cable along a central axis;
a blade having a cutting edge, the blade secured to the housing so that the cutting edge protrudes into the central opening;
a ramp assembly having a cable support portion, a ramp base, and a biasing member, the cable support portion being pivotally connected to the ramp base, the ramp assembly being secured to the housing so that the ramp base protrudes into the central opening diametrically opposite the cutting edge; and
a clearance window passing from the central opening through the housing and being positioned with respect to the blade so that an insulation chip produced during removal of the insulation from the cable, during rotation of the housing and cable with respect to one another about the central axis, travels through the clearance window and away from the housing,
wherein the biasing member biases the cable support portion away from the ramp base towards the central opening and the cutting edge.

2. The tool according to claim 1, wherein the biasing member is a compression spring.

3. The tool according to claim 2, wherein the ramp assembly further comprises a first spring land in the cable support portion that is configured and positioned to receive one end of the compression spring and a second spring land in the ramp base that is configured and positioned to receive another end of the compression spring.

4. The tool according to claim 1, wherein the ramp assembly further comprises a hinge pin and a hinge knuckle pivotally securing the cable support portion and the ramp base to one another.

5. The tool according to claim 1, wherein the ramp assembly further comprises a living hinge pivotally securing the cable support portion and the ramp base to one another.

6. The tool according to claim 1, further comprising a blade bridge disposed adjacent to the blade, the blade bridge having a portion that extends into the central opening further than the blade.

7. A tool for removing insulation from a cable, the tool comprising:
a housing having a central opening for insertion of a cable end and a housing outer surface;
a blade having a cutting edge, the blade secured to the housing wherein the cutting edge protrudes into the central opening;
a projection secured to the housing including a movable cable support portion extending into the central opening opposite the blade, the cable support portion biased toward a central axis of the housing; and
a clearance window disposed adjacent the blade, the clearance window extending from the central opening to the housing outer surface whereby a chip produced during insulation removal travels through the window and away from the tool housing;
wherein the cable support portion of the projection urges a portion of the cable inserted into the central opening toward the blade; and
wherein the insulation of the cable is cut by the blade edge and urged through the clearance window when the cable is rotated with respect to the tool housing.

8. The tool according to claim 7, wherein the protrusion is a ramp having a first profile depth at an end of the housing where the cable is inserted and a larger second profile depth toward an opposite end of the housing.

9. The tool according to claim 7, wherein the housing is cylindrical.

10. The tool according to claim 7, further comprising a blade bridge disposed adjacent the blade wherein a portion of the blade bridge extends further into the central opening than the blade, the bridge ensuring that the blade cannot touch the exposed conductor downstream of the strip regardless of how much the cable orbits in the central opening.

11. The tool according to claim 7, wherein the projection is secured to an end of a projection base and an end of the cable support portion, the projection base secured tightly to the tool housing, wherein the movable cable support portion urges the cable against the blade.

12. The tool according to claim 11, further comprising a spring extending between the projection base and the cable support portion, urging the cable support portion toward the central axis wherein a cable is inserted into the central opening is urged against the blade cutting edge.

13. A method for removing insulation from a cable, the method comprising:
providing a tool having a housing having a central opening for insertion of a cable end and a housing outer surface, a blade having a cutting edge, the blade secured to the cylindrical housing wherein the cutting edge protrudes into the central opening, a projection movably secured to the hosing, a portion of the projection extending into the central opening opposite the blade, the projection biased toward a central axis of the housing and a clearance window disposed adjacent the blade, the clearance window extending from the central opening to the housing outer surface whereby a chip produced during insulation removal travels through the window and away from the tool housing;
providing a cable having insulation on the exterior surface of the cable; inserting the end of the cable into the central opening;
allowing the projection to urge the cable against the blade; and
rotating the cable in the central opening or rotating the tool housing about the cable wherein the insulation of the cable is cut by the blade edge and urged through the clearance window when the cable is rotated with respect to the tool housing.

14. The method according to claim 13, wherein the tool includes a blade bridge disposed adjacent the blade wherein a portion of the blade bridge extends further into the central opening than the blade, and wherein the step of rotating the cable in the central opening includes the bridge ensuring that the blade cannot touch the exposed conductor.
